(19) United States
(12) Patent Application Publication
(10) Pub. No.: US 2008/0108300 A1
(43) Pub. Date: May 8, 2008

(54) SYSTEM, METHOD, COMPUTER PROGRAM PRODUCT, AND COMPUTER READABLE MEDIUM FOR NEW NODE JOINING THE WIRELESS NETWORK

(75) Inventors: Chi-Wen Teng, Sanchong City (TW); Chih Lung Chang, Jhonghe City (TW); Yung-Chih Liu, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: Institute for Information Industry, Taipei (TW)

(21) Appl. No.: 11/677,939

(22) Filed: Feb. 22, 2007

(30) Foreign Application Priority Data
Nov. 6, 2006 (TW) 095141020

(51) Int. Cl. H04H 1/00

(52) U.S. Cl. 455/3.01

(57) ABSTRACT

A system, a method, a computer program product, and a computer readable medium thereof for a new node joining a wireless network are disclosed. The wireless network system comprises a plurality of child nodes and a plurality of father nodes corresponding to those child nodes. Each of the child nodes and each of the father nodes can send a beacon packet, which comprises an absolute time index and a relative time index. When the new node collects the absolute time indexes and relative time indexes of neighboring child nodes, it can calculate the occupied absolute time index quickly and derive its absolute time index from the unoccupied absolute time index. Based on the same reason, when applying the system to a scheduling algorithm, the scheduled result can be derived quickly. In addition, the system can prevent the accumulated error. The system can be applied to a low-rate wireless network.

This application claims priority to Taiwan Patent Application No. 095141020 filed on Nov. 6, 2006, the disclosures of which are incorporated herein by reference in its entirety.

### CROSS-REFERENCES TO RELATED APPLICATIONS

Not applicable.

### BACKGROUND OF THE INVENTION

1. Field of the Invention

The subject invention relates to a wireless network, a method and a computer readable medium for a new node joining the wireless network. More particularly, the present inventions relates to a wireless network, a method and a computer readable medium for a new node joining the wireless network by an absolute time index without scheduling collision.

2. Descriptions of the Related Art

A low-rate wireless network device is highly emphasized in areas of home appliances, toys, industry, insurance and medical care. With the characteristics of low cost, low power consumption, and easy to dispose, the low-rate wireless network is especially suitable for applications of low maintenance and wide service range. In every kind of low-rate network communication protocols, the most representative one is an IEEE 802.15.4/ZigBee.

In a ZigBee wireless network, a coverage range is limited by strength of a wireless electric wave thereof. If a service range with a large area is desired to be built, usually, network relay nodes are required to make the coverage range of the wireless electric wave join into the large area wireless service range. However, each of the nodes will enter a power-saving state for saving power, such as shutting down a wireless antenna. This will cause the node fail to receive the packet correctly which further leads to a problem of packet lose.

To solve this problem, please refer to FIG. 1 which depicts an operation module of a beacon-enable device. In FIG. 1, B represents a beacon and T represents a beacon interval between two beacons. The beacon interval T is further divided into an active period (i.e., a superframe duration) S and an inactive period I. After listening to the beacon, the device will perform transmitting and receiving actions in the active period and stop those actions in the inactive period. The above-mentioned characteristic enables a device to act periodically and suspend in the inactive period I to achieve the aforementioned objective of power-saving. In detail, the aforementioned active period is equally divided into 16 time slots and any equipment has to transmit data within these 16 time slots.

A ZigBee wireless network comprises a plurality of nodes. Since limited resource, while the node (i.e., the aforementioned beacon-enable device) of the wireless network performs a periodical action, actions of each of the nodes in the active period have to be scheduled to stagger each transmitting time of the neighboring nodes for avoiding time index collisions among the nodes. In other words, each of the nodes has to assign a required time slot in the 16 time slots.

If a new node intends to join a scheduled wireless network, the new node has to choose an unselected time slot for transmitting data. A physical approach is that the new node will listen to beacon packets of each of the nodes in the network within a period of time and record time indexes of these beacons, wherein the beacon packet comprises a transmitting time for each of the nodes relative to corresponding father node. At last, messages in the beacon packets are retrieved to calculate signal transmitting time indexes of these father nodes to help the new node in choosing a time slot among unoccupied idle time slots as its own signal transmitting time slot and choosing a neighboring node as its own father node.

It is emphasized that since current specification of the ZigBee provides a relative time as a standard for time calculation, each of the nodes can simply based on the chosen father node to calculate its own relative time index (i.e., in corresponding to the time index of the father node) and unable to know an absolute time index in the whole network. Therefore, the new node has to record and receive beacon times transmitted by neighboring nodes for a following work of analysis and calculation to obtain each transmitting time of each of the neighboring nodes relative to each of corresponding father nodes. However, aspects of time analysis and hardware transmitting and receiving may cause an error in recording which leads to a time-consuming calculation and may further lead to mistakes of scheduling collisions.

Moreover, the ZigBee wireless network sometimes requires scheduling algorithms to schedule time indexes of nodes in the wireless network. The scheduling algorithms require absolute time indexes of nodes to schedule. However, limited by information of a relative time provided by the ZigBee only, the scheduling algorithms have to make an assumption for an absolute time of each of the nodes and cannot achieve an effect of dynamic scheduling.

Based on this reason, for saving power consumption of the wireless network and reducing problems of scheduling collision for signal transmitting, it is necessary to improve the scheduling method for signal transmitting in present wireless network.

### SUMMARY OF THE INVENTION

An objective of the subject invention is to provide a wireless network system which can easily fulfill a multi-hop wireless network to achieve a balanced objective of power consumption and transmission delay. The wireless network comprises a plurality of child nodes and a plurality of father nodes corresponding to the child nodes, wherein each of the child nodes and each of the father nodes can send a beacon packet. Each the beacon packet comprises an absolute time index and a relative time index, and the absolute time index and the relative time index of each of the child nodes can be used to calculate the absolute time index of the father node corresponding to the child node for optimizing system scheduling.

Another objective of this invention is to provide a method of a new child node joining a wireless network, wherein the wireless network comprises a plurality of neighboring child nodes which are close to the new child node and a plurality of father nodes corresponding to the neighboring child nodes. The method comprises: receiving a beacon packet sent from each of the plurality of neighboring child nodes, wherein the beacon packet comprises an absolute time index and a relative time index of each of the neighboring child nodes; calculating an absolute time index for each of the father nodes according to the absolute time index and the relative time index of the corresponding neighboring child nodes; and choosing a time interval, excluding the absolute time indexes of the neighboring child nodes and the father nodes, as an absolute time index of the new child node. The disclosed method of this invention can reduce calculation overhead of a microprocessor in each node and substantially avoid extra truncation errors and mistakes caused by a timing error of a processor. This invention can also make each of the nodes obtain its own absolute time index in the whole network for optimizing the schedule for signal transmission.

Yet another objective of this invention is to provide a computer readable medium that stores a computer program for executing the aforementioned method. A further objective of this invention is to provide a computer program product for executing the aforementioned method.

To make the mentioned objective, skill characteristic, and advantage of this invention could be easier to understand, better embodiments with the attached figures for detailed description in the following paragraph. The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of an operation module of a conventional beacon-enable device;

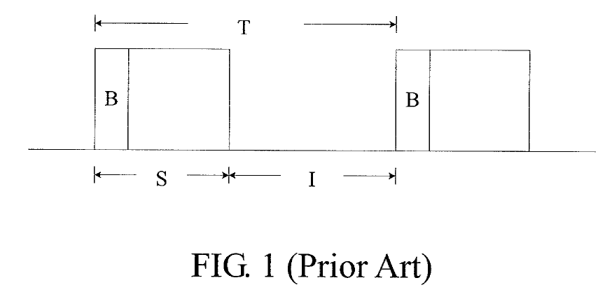

FIG. 2 is a flow chart of a method of the invention for joining a new node to a wireless network system; and

FIG. 3 is a schematic diagram of an embodiment of the invention for joining a new node to a wireless network system.

### DESCRIPTION OF THE PREFERRED EMBODIMENT

This invention discloses a wireless network to solve possible scheduling collision problems while transmitting signals. The wireless network comprises a plurality of child nodes and a plurality of father nodes corresponding to the child nodes. Compared with the prior art, beacon packets sent by each of the child nodes and each of the father nodes comprises information of an absolute time index and a relative time index in the wireless network disclosed by this invention. An absolute time index of the father node corresponding to each of the child nodes can be determined by the information of the absolute time index and the relative time index. While each of the nodes knows its own absolute time index in the whole network, a scheduling arrangement of the signal transmission can be done easily according to the absolute time index for determining the time for signal transmitting of each of the nodes (comprising the child nodes and the father nodes) to solve the time-consuming scheduling problem of the prior art. It is worth to mention that each of the child nodes and each of the father nodes are devices capable of wireless transmission.

In a preferred embodiment, the absolute time index of the father nodes corresponding to each of the child nodes is obtained by subtracting the relative time index from the absolute time index of each of the child nodes, while the absolute time index and the relative time index are stored in a beacon packet which is defined in a Media Access Control (MAC) layer. In a real application, the absolute time index and the relative time index are separately stored in a first field (such as bits 24^{th} to 31^{st} of the beacon packet in the ZigBee wireless network) and a second field (such as bits 31^{st} to 38^{th} bit of the beacon packet in the ZigBee wireless network) of the beacon packet to replace the relative time index corresponding to the father nodes stored in the conventional beacon packet.

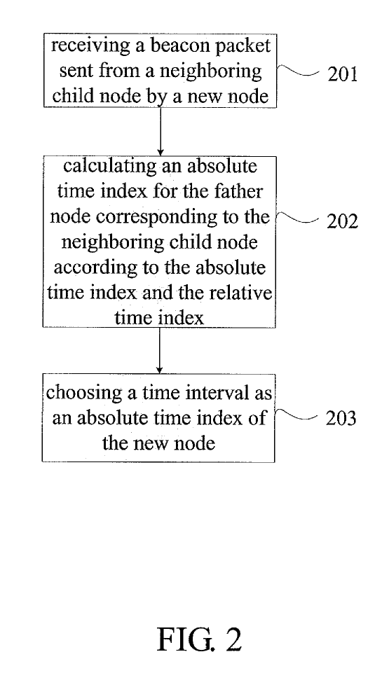

Applying the aforementioned wireless network disclosed in the invention, a method for joining a new node to the wireless network is also provided as depicted in FIG. 2. The wireless network comprises a plurality of child nodes as mentioned above, close to the new child node, called as a plurality of neighboring child nodes, and a plurality of father nodes corresponding to the neighboring child nodes. The method comprises the steps of:

First, in step 201, the new child node listens to a beacon sent from the wireless network in a fixed period of time. After the new node has listened to the beacon, the new child node will receive a beacon packet sent from each of the child nodes close to the new node, wherein the beacon packet comprises an absolute time index and a relative time index of each of the neighboring child nodes, and after listening the new node records the beacon packet received from each of the neighboring child nodes into a neighboring table for the following operation for scheduling management.

Next, in step 202, the new child node calculates every absolute time index of each of the father nodes respectively according to the absolute time index and the relative time index of each of the neighboring child nodes to obtain the absolute time index of each of the father nodes corresponding to the neighboring child nodes in the wireless network. The value obtained by subtracting the relative time index from the absolute time index of each of the neighboring child nodes is the absolute time index of each of the father nodes corresponding to the neighboring child nodes.

Finally, in step 203, excluding the absolute time indexes of the neighboring child nodes and the father nodes, a suitable time interval is chosen as an absolute time index of the new child node. In another word, the new child node must avoid transmitting information in the absolute time indexes of these neighboring child nodes while choosing the time interval for signal transmission without scheduling collision. Moreover, it is also essential to avoid transmitting information during the absolute time indexes of the father nodes of the neighboring child nodes. In addition, this invention enables each node to obtain its own absolute time index in the whole network, and accordingly, benefits to optimize a signal transmission scheduling in the whole network system.

In a real application, the step of choosing a time interval as an absolute time index by the new child node further comprises the step that the new child node chooses one of the neighboring child nodes as its father node and calculates its relative time index. For instance, but not limited to this instance, the new child node chooses a neighboring child node with a strongest beacon strength as its father node. In other words, the value obtained by subtracting the absolute time index of the father node chosen by the new child node from the absolute time index of the new child node is the relative time index of the new child node.

It is emphasized that while applying the system and method of this invention, the absolute time index and the relative time index are stored in the beacon sent from each node. Therefore, the new child node can easily calculate the absolute time index in the wireless network to reduce calculating overhead of a microprocessor and further avoid extra truncation errors and mistakes caused by a timing error of a processor.

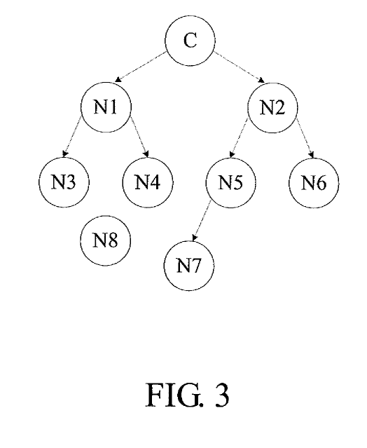

The following is a physical embodiment to explain the aforementioned method. Please refer to FIG. 3 which depicts a wireless network comprising seven nodes N1, N2, N3, N4, N5, N6, and N7, and a coordinator C, wherein the coordinator C is responsible for building a ZigBee wireless network which comprises a three-layer network system composed of the node N1 to the node N7. Each node comprises the aforementioned characteristics.

When a node N8 intends to join the wireless network, the node N8 will listen to a beacon sent from the ZigBee wireless network in a fixed time interval. After listening to the beacon, the node N8 will receive the beacon packets sent from each of the child nodes close to the new node. In this embodiment, the neighboring nodes of the node N8 is the node N3, N4 and N7 so that node N8 respectively receives the beacons sent from the node N3, N4 and N7, and stores absolute time indexes and relative time indexes in the beacon packets to a neighboring table of the node N8 for determining time indexes of the node N3, N4 and N7, specifically for deriving time indexes sent from each of the father nodes of the node N3, N4 and N7.

In this embodiment, the absolute time index of the node N3 is 3, the relative time index is 2; the absolute time index of the node N4 is 4, the relative time index is 3; the absolute time index of the node N7 is 7, and the relative time index is 2. Therefore, the absolute time index of each of the neighboring nodes (N3, N4, and N7) received by the node N8 are 3, 4, and 5, respectively. On the other hand, the absolute time indexes of the father nodes (N1, N5) corresponding to the neighboring nodes (N3, N4, and N7) are differences calculated by the absolute time indexes and the relative time indexes of the node N3 (or N4) and N7, which are 3−2=1, 4−3=1, and 7−2=5, respectively. Therefore, the node N8 has to avoid the absolute time index of 1, 3, 4, 5, and 7. In other words, the node N8 can determine the time interval of 2, 6, 8, 9, etc., to be an available time index. Accordingly, the node N8 can choose a suitable time interval as its own time index for sending messages and know the sequence of its time index in the time intervals of the whole network.

According to mentioned descriptions, if the node N3 has strongest beacon strength among the neighboring nodes (in this example, N3, N4, and N7) of the node N8, the node N8 can choose the node N3 as its father node. If the node N8 chooses a time interval of 6 as its absolute time index, the relative time index of the node N8 is a difference value of 3 between the absolute time index 6 of N8 and the absolute time index 3 of N3. In other word, the beacon sending from the node N8 will comprise packet information of the absolute time index 6 and the relative time index 3. Utilizing this method, each node clearly knows its absolute and relative time indexes in the whole system. Therefore, not only a complete multi-hopping wireless network can be implemented easily to optimize the scheduling of information transmission in the whole system, but also no truncation error and problem of time analysis exists. The problems of scheduling collision in prior art techniques can be solved.

This invention can also use a computer readable medium to store a computer program to execute the aforementioned steps. The computer readable medium can be a floppy disk, a hard disk, an optical disc, a flash disk, a tape, a database accessible from a network, or a storage medium with the same functionality for people who are ordinary skilled in the art.

The above examples are only intended to illustrate the principle and efficacy of the subject invention, not to limit the subject invention. Any people skilled in this field may proceed with modifications and changes to the above examples without departing from the technical principle and spirit of the subject invention. Therefore, the scope of protection of the subject invention is covered in the following claims as appended.

What is claimed is:

1. A wireless network system, comprising:
a plurality of child nodes; and
a plurality of father nodes corresponding to the child nodes, wherein each of the child nodes and each of the father nodes can send a beacon packet, each the beacon packet comprises an absolute time index and a relative time index, and the absolute time index and the relative time index of each of the child nodes can be used to calculate the absolute time index of the father node corresponding to the child node.

2. The wireless network system of claim 1, wherein the value obtained by subtracting the relative time index from the absolute time index of each of the child node is the absolute time index of the father node corresponding to the child node.

3. The wireless network system of claim 1, wherein the absolute time index of each of the child nodes and the father nodes is used to calculate the signal-transmitting time of the child node or father node.

4. The wireless network system of claim 1, wherein the beacon packet is defined at a Media Access Control (MAC) layer.

5. The wireless network system of claim 4, wherein the absolute time index and the relative time index are stored in a first field and a second field of the beacon packet respectively.

6. The wireless network system of claim 1, wherein each of the child nodes and the father nodes is a device capable of wireless transmission.

7. A method for a new node joining a wireless network, comprising the steps of:
receiving a beacon packet sent from each of a plurality of neighboring child nodes, wherein the neighboring child nodes are close to the new node, the wireless network comprises the neighboring child nodes and a plurality of father nodes corresponding to the neighboring child nodes, and each of the beacon packets comprises an absolute time index and a relative time index of one of the neighboring child nodes;
calculating an absolute time index for each of the father nodes according to the absolute time index and the relative time index of the corresponding neighboring child nodes; and
choosing a time interval, excluding the absolute time indexes of the neighboring child nodes and the father nodes, as an absolute time index of the new node.

8. The method of claim 7, further comprising a step of listening to a beacon sending from the wireless network in a fixed time interval by the new node, wherein the step of receiving the beacon packet sent from each of the neighboring child nodes is executed after the new node has listened to the beacon.

9. The method of claim 8, wherein the new node stores the beacon packets received after having listened to the beacon in a neighboring table.

10. The method of claim 7, further comprising a step of choosing one of the neighboring child nodes as a father node of the new node.

11. The method of claim 10, wherein the new node chooses the neighboring node with a strongest beacon strength as the father node of the new node.

12. The method of claim 7, wherein the value obtained by subtracting the relative time index from the absolute time index of each of the neighboring child nodes is the absolute time index of the father node corresponding to the neighboring child node.

13. The method of claim 7, wherein each of the neighboring child nodes and the father nodes is a device capable of wireless transmission.

14. A computer readable medium, storing an application program for executing a method for a new node joining a wireless network, the method comprising the steps of:
receiving a beacon packet sent from each of a plurality of neighboring child nodes, wherein the neighboring child nodes are close to the new node, the wireless network comprises the neighboring child nodes and a plurality of father nodes corresponding to the neighboring child nodes, and each of the beacon packets comprises an absolute time index and a relative time index of one of the neighboring child nodes;
calculating an absolute time index of each of the father nodes according to the absolute time index and the relative time index of the corresponding neighboring child nodes; and
choosing a time interval, excluding the absolute time indexes of the neighboring child nodes and the father nodes, as an absolute time index of the new node.

15. The computer readable medium of claim 14, further comprising a step of listening to a beacon sending from the wireless network in a fixed time interval by the new node, wherein the step of receiving the beacon packet sent from each of the neighboring child nodes is executed after the new node has listened to the beacon.

16. The computer readable medium of claim 15, wherein the new node stores the beacon packets received after having listened to the beacon in a neighboring table.

17. The computer readable medium of claim 14, further comprising a step of choosing one of the neighboring child nodes as a father node of the new node.

18. The computer readable medium of claim 17, wherein the new node chooses the neighboring node with a strongest beacon strength as the father node of the new node.

19. The computer readable medium of claim 14, wherein the value obtained by subtracting the relative time index from the absolute time index of each of the neighboring child nodes is the absolute time index of the father node corresponding to the neighboring child node.

20. The computer readable medium of claim 14, wherein each of the neighboring child nodes and the father nodes is a device capable of wireless transmission.
